(19) United States
(12) Patent Application Publication
(10) Pub. No.: US 2020/0203039 A1
(43) Pub. Date: Jun. 25, 2020

(54) COLORED WIRE OR CABLE AND METHOD AND APPARATUS FOR COLORING WIRE OR CABLE

(71) Applicant: Cerro Wire LLC, Hartselle, AL (US)

(72) Inventors: Dale L. Crawford, Pleasant View, UT (US); Steve Mickey, Hartselle, AL (US)

(73) Assignee: Cerro Wire LLC, Hartselle, AL (US)

(21) Appl. No.: 16/803,717

(22) Filed: Feb. 27, 2020

Related U.S. Application Data
(62) Division of application No. 14/862,991, filed on Sep. 23, 2015.
(60) Provisional application No. 62/053,881, filed on Sep. 23, 2014.

(51) Int. Cl. H01B 7/36; H01B 13/34; H01B 13/30; H01B 3/30

(52) U.S. Cl. CPC H01B 7/361; H01B 13/345; H01B 7/0216; H01B 3/305; H01B 13/30

(57) ABSTRACT

A process for coloring post-production cables or coloring cables in an in-line manufacturing process can include coloring a polymer coated conductive cable or wire using a colorant solution. In one example, the wire can be passed through a trough, bath or spray of the colorant solution. In one example, the colorant can have a transparent characteristic to it in order to allow the printing on the cable to show through the colorant applied to the cable.

### CROSS-REFERENCE TO RELATED APPLICATIONS

This application is a divisional application of U.S. patent application Ser. No. 14/862,991, filed Sep. 23, 2015, which claims priority to U.S. Provisional Application No. 62/053,881, filed Sep. 23, 2014. The above referenced applications are incorporated in their entirety by reference.

### FIELD

The present disclosure relates generally to coloring wire or cable (“cable”) in a post-production process or in-line production process.

### BACKGROUND

Electrical wire or cable customers often require certain color wires or cables. Color can be added to the cable insulation and jacketing during and/or through the extrusion process that occurs when the polymer insulation and/or jacketing are applied over the top of the conductor forming the cable.

High costs are associated with maintaining a large selection of colored cable. Traditionally, customers require multiple colors of cable in multiple gauges and often demand cable to be available upon request. Due to the need to stock every color of every gauge size of wire and cable, inventories must be robust in order to stay competitive in the marketplace. Also for this reason, raw material costs and labor can be very high due to color change requirements.

In certain instances, therefore, it may be desirable to add coloring to the cable after it is coated with a polymer insulation and/or jacket either after the production process or concurrently with the wire production process. However, in the case of a THHN style cable, an amide or nylon is generally difficult to color, and the coloring of nylon can be a more difficult process than coloring PVC because, for example, amide or nylon typically requires a lengthy time to color (several minutes in a heated colorant bath). In the following paragraphs some examples are given referring to a type THHN electrically conductive building wire construction. However, this is not intended to limit the process from being used in conjunction with other types of wire/cable, conductive or non-conductive.

### SUMMARY

This Summary provides an introduction to some general concepts relating to this invention in a simplified form that are further described below in the Detailed Description. This Summary is not intended to identify key features or essential features of the invention.

A process for coloring cables post-production or coloring cables in-line with the manufacturing of the cables can include coloring a polymer or amide coated conductive cable or wire using a water-based or solvent-based colorant solution. In one example, the cable can be passed through a trough, bath, or spray (or some other method of introduction) of the colorant solution. In one example, the colorant can have a transparent characteristic to allow the printing on the cable to appear through the colorant applied to the cable.

### BRIEF DESCRIPTION OF THE DRAWINGS

The foregoing Summary, as well as the following Detailed Description, will be better understood when considered in conjunction with the accompanying drawings in which like reference numerals refer to the same or similar elements in all of the various views in which that reference number appears.

FIG. 1A shows a side perspective view of an exemplary system for coloring cable in either a post-production process or an in-line manufacturing process.

FIG. 1B shows a top perspective view of the exemplary system of FIG. 1A.

FIG. 2 depicts an exemplary schematic of a process for coloring cable in a post-production process or an in-line manufacturing process.

FIG. 3 depicts an example cross-section of cable colored by the exemplary process of FIG. 2.

FIGS. 4A and 4B are flow charts showing an exemplary sequence of operation for coloring cable in a post-production process or an in-line manufacturing process.

### DETAILED DESCRIPTION

In the following description of the various examples and components of this disclosure, reference is made to the accompanying drawings, which form a part hereof, and in which are shown by way of illustration various example structures and environments in which aspects of the disclosure may be practiced. It is to be understood that other structures and environments may be utilized and that structural and functional modifications may be made from the specifically described structures and methods without departing from the scope of the present disclosure.

In one example, a process for coloring cable can include coloring polymer (amide) coated conductive wire/cable (“cable”) using a water-based or solvent-based colorant or solution for coloring the cable. In one specific example, the colorant could be a dye solution. In one example, the cable can be a cable with a typical uncolored insulation and jacket, and the cable may have one or multiple polymer coatings consisting of one or multiple polymers. In one example, the cable can have all the necessary markings including the manufacturer, size, date of manufacture and can be white cable that is otherwise ready for selling on the market. It is contemplated that the processes discussed herein can be implemented on post-production cable or in an in-line manufacturing process, for example, after the cable is jacketed with a polymer or amide, the cable could be colored using the processes discussed herein.

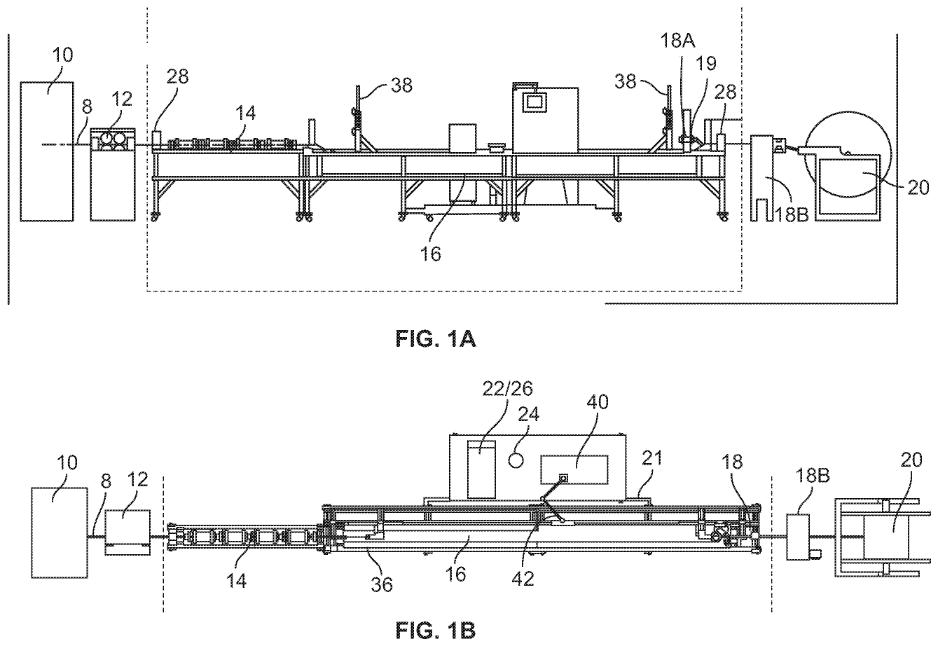

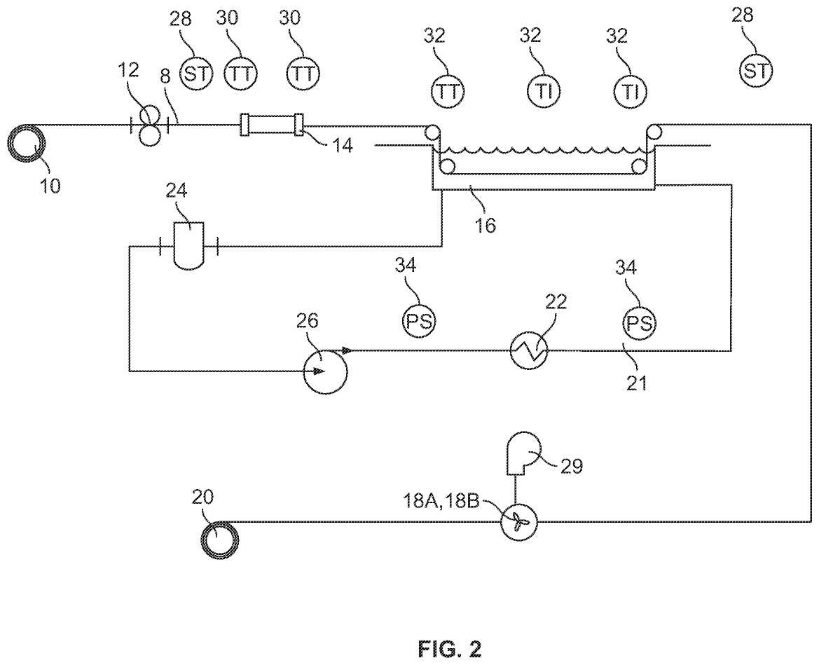

FIGS. 1A and 1B depict an example system for coloring a conductive wire or cable 8. As shown in FIGS. 1A and 1B, the coloring system can include a payoff reel 10 for loading cable to be colored, a cable puller 12, which can be a cat-track puller for advancing the cable, a heater 14 for preheating the cable, a trough 16 for submerging the cable in the colorant, air wipes 18A, 18B for removing the excess colorant, and a take-up reel 20 for receiving the colored cable 8.

Additionally, the trough 16 can be connected to a colorant supply line 21, which can be configured to circulate the colorant through a heater 22 and a filter 24 via pump 26. The trough 16 can incorporate pneumatic actuators 38, which also may include adjustable hard stops and shock absorbers. This allows for the cable to be raised and lowered to introduce the cable to the colorant solution, for example.

The example system can be provided with various controls. For example, an interface 40 for operating the system can be provided that can be mounted to an articulated arm 42. Additionally, an emergency-stop cord 36 can also be provided for interrupting the operation of the coloring procedure.

Although not shown, the colorant supply line 21 can also be connected to a colorant supply to provide additional colorant to the trough 16. The system may also include various sensors for detecting the parameters of the system to ensure that the system is running properly including: pressure switches 34, speed transmitters 28, temperature indicators 32, and temperature transmitters 30. Additionally, electronics may be provided to monitor and control the resultant color density, shade, and hue of the cable being processed.

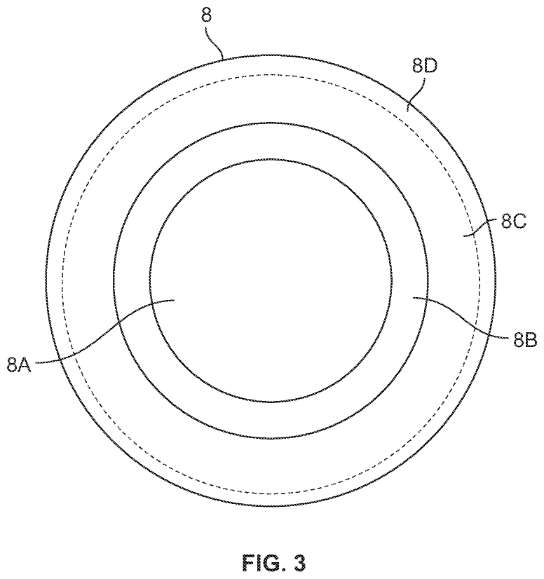

The process of coloring a cable in a post-production process, such as a polymer or amide coated conductive cable or wire, will now be described in relation to the schematic of FIG. 2. The cable 8 can be supplied on a payoff reel 10 and is advanced by a cable puller 12 into the system. The cable puller 12 can be set at a predetermined speed, which depends on the desired residence time for the cable 8 to be introduced to the colorant. In one example, the speed of the cable 8 can be set at 50 ft/min to 1000 ft/min.

Additionally, the tension of the cable 8 can be set by the cable puller 12 so as to maintain a safe advancement of the cable 8 through the system. In one example, the system can be provided with a shut-off mechanism, e.g. emergency stop cord 36, as well as a shut-off mechanism which stops the cable 8 from advancing if the tension in the cable 8 reaches a certain threshold to avoid damage to the cable 8 and for operator and equipment safety. In one example, the cable 8 can be heated by a heater 14. Heating the cable 8 generally opens up the microscopic pores located in the nylon covering such that the nylon absorbs and retains the colorant. In one example, the cable 8 can be heated to a temperature of 100° F. to 300° F.

As shown in FIG. 2, the cable 8 can be passed through trough 16 containing the colorant solution to receive the colorant. The cable 8 is maintained in the trough 16 for a predetermined residence time to ensure that the colorant is properly absorbed by the cable 8. In one example, the residence time can range from a fraction of a second to many seconds. It is also contemplated that the trough 16 can be a bath or spray (or some other method of introduction). In the example where a spray is used, the spray can be pressurized such that the colorant is pushed into the nylon of the cable 8.

As shown in FIG. 2, the colorant supply line 21 can pass through a heater 22 which can raise the temperature of the colorant. In one example, the colorant can also be heated to a temperature of 130-230° F. In another example, the colorant can be heated to 180-212° F. In one specific example, the colorant can be heated as close as possible to water boiling temperature of 212° F. Again this helps the microscopic pores of the nylon to swell or open so that the colorant can permeate into the porous surface of the nylon in order to absorb and retain the colorant. However, it is contemplated that both, either, or neither of the colorant or cable be heated depending on the desired color density, shade, and/or hue of the colored cable.

Also a filter 24 can be used to filter sediment or unwanted particles that enter the system during the coloring operation from the colorant solution. Additionally, to help avoid the buildup of sediment in the colorant solution, the pH of the solution can be controlled by adding buffer solutions, which can include an acid and/or salt to help maintain a consistent pH level.

The colorant solution pump 26 pumps the colorant solution from the trough 16 to the filter 24 and through the heater 22 and ultimately back into the trough 16 for coloring the cable 8. It is also contemplated that the colorant supply line 21 and pump 26 can be connected to a colorant solution tank, which is configured to add additional colorant solution as needed. However, other methods of colorant addition are also contemplated.

Once the cable 8 exits the trough 16, the cable 8 can then be transferred to one or more air wipes 18A, 18B, where air is blown onto the cable 8 to remove the excess colorant and to generally cool and dry the cable 8. A pump 29, or compressed air supply, can be provided for supplying the air to the air wipe. Although not shown, the air wipes 18A, 18B can include a series of nozzles for projecting air at the cable 8. For example, an air manifold can be provided with a series of nozzles extending therefrom, and the air manifold can be connected to the air pump 29 (or pressurized air supply) to direct the air at the cable 8. Finally, a take-up reel 20 receives the colored cable 8 and the process is complete.

In one example, the process can be controlled automatically using electronics to measure and control any parameter, including; speed, temperature, colorant solution, tension, etc. Various sensors for detecting these parameters can be placed throughout the system, and the system can receive various feedback from one or more of the pressure switches 34, speed transmitters 28, temperature indicators 32, and temperature transmitters 30. Additionally, if any of the sensors detect a hazardous or faulty parameter, the system can automatically shut down or otherwise send a warning signal either audibly or electronically to the operator of the system.

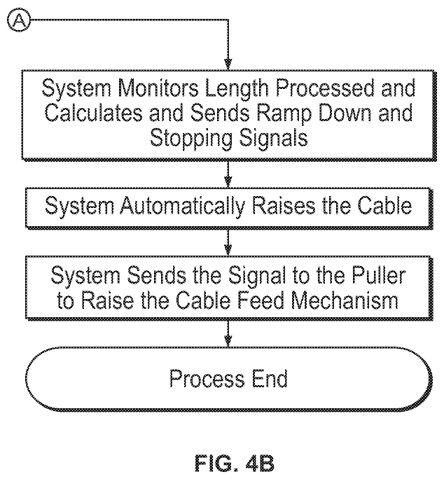

FIGS. 4A and 4B illustrate an exemplary sequence of operation for the manual set-up of the process and system described above for coloring cable in a post-production process or an in-line manufacturing process.

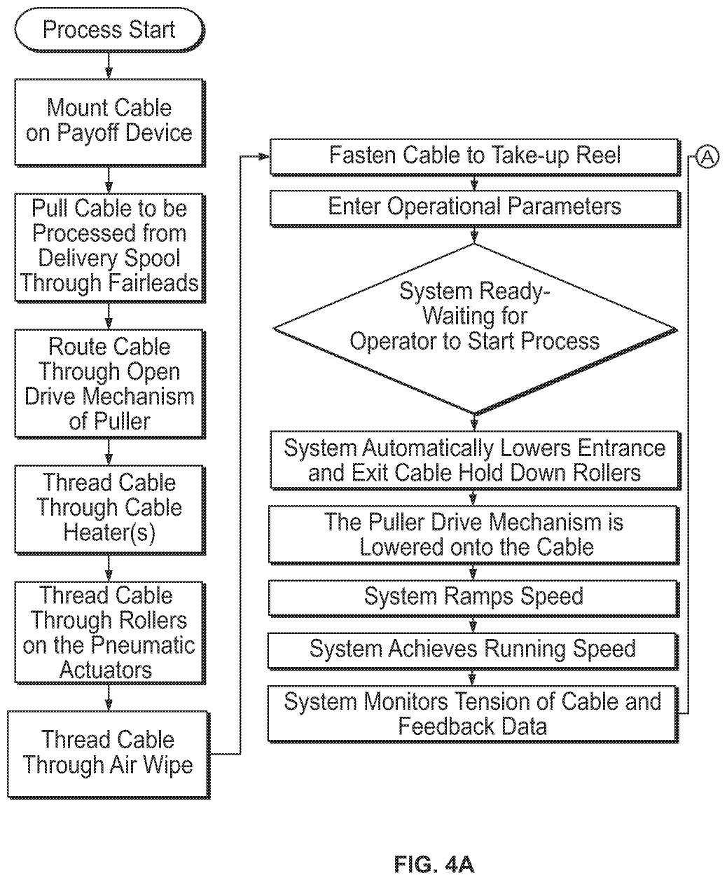

FIG. 3 shows a cross-sectional view of a colored cable. In one embodiment, as shown in FIG. 3, the colored cable consists of layers, which include a stranded or solid cable layer 8A, a PVC coating layer 8B, a nylon coating layer 8C, and a colored portion 8D of the nylon coating layer 8C. The cable layer 8A, PVC coating layer 8B, and the nylon coating layer 8C can be formed under known methods, e.g. extruding the insulation and jacketing over the top of the cable. The colored portion 8D is added as discussed herein. As depicted in FIG. 3, the colored portion 8D does not extend all the way through the nylon coating layer 8C. Rather, it is only absorbed a certain distance into the nylon layer 8C or adhered to the surface of the nylon layer. Therefore, when viewed from a cross-sectional view, a portion of the uncolored section or a white section of the nylon layer 8C will remain covering the PVC coating layer 8B and the cable layer 8A.

In one example, the density of the color of the colored cable is designed to not obscure the UL required data (UL legend) printed on the cable. Also, the coloring process does not appreciably affect the mechanical, electrical, or aging properties of the cable. If the cable or the colorant is to be heated in the process, this should not affect the adhesion between the nylon and PVC. Testing illustrates that the adhesion properties between the nylon and the PVC are not affected by the process described herein. The color adheres to the surface of the cable and does not flake off. Additionally, a slip agent is included as a component in the polymer of the stock cable, and the colorant should not affect the friction reducing properties of the slip agent in the jacketing polymer of the cable. The coloring process should also not affect the UL flame test or the tensile, elongation, and cold bend test. Various testing was conducted to ensure these characteristics.

Samples of the colored THHN cable were tested under the tensile and elongation tests as set forth in § 4.2 of UL Standard 2556, which is fully incorporated by reference as set forth herein. The purpose was to determine the ultimate elongation and tensile strength of insulation and jacket materials of the colored cable. The results of the tensile and elongation testing of the colored cable appear in table 1 below.

TABLE 1

| Type | Elongation | Break Load | Area | PSI |
|---|---|---|---|---|
| 4/0 Regular | | | | |
| PVC | 325% | 29.6 | 0.0095 | 3116 |
| Nylon | 363% | 12.1 | 0.0011 | 11000 |
| 4/0 Blue | | | | |
| PVC | 313% | 31.7 | 0.01 | 3170 |
| Nylon | 363% | 16.4 | 0.0015 | 10933 |
| 4/0 Orange | | | | |
| PVC | 213% | 30.4 | 0.012 | 2533 |
| Nylon | 363% | 12.9 | 0.0013 | 9923 |

Samples of the colored THHN cable were tested under the VW-1 vertical flame test UL standard 2556 as set forth in NMX-J-556-ANCE-2007, which is incorporated by reference as fully set forth herein. The purpose of this test is to determine the resistance of the cable to the vertical propagation of flame and dropping of flaming particles of the colored cable. The results of the vertical flame testing of the colored cable appear in table 2 below.

TABLE 2

| | Flame Application | | | | | |
|---|---|---|---|---|---|---|
| | #1 | #2 | #3 | #4 | #5 | |
| SAMPLE NO. | (sec) | (sec) | (sec) | (sec) | (sec) | Comments |
| 1 | 1 | 2 | 2 | 3 | 2 | Passed |
| 2 | 9 | 1 | 1 | 5 | 1 | Passed |

A cold bend test was conducted according to NMX-J-556-ANCE-2007, CSA C22.2 No. 2556-07, UL2556, which is fully incorporated by reference as set forth herein. This test was conducted on 4/0 THHN blue and 4/0 THHN orange cable, which were colored according to the processes set forth herein. In conducting the test no cracks in the nylon or PVC insulation were observed.

The colorant properties can be determined based on the desired color, density, shade, and/or hue. In one example, the colorant can be an azo disperse #3 dye. In one particular example, the colorant can be Dura Dye Hot Dye #3. The colorant can have a transparent characteristic to allow the printing on the cable to show through the colorant applied to the cable. For example, if it is necessary to be able to read the UL legend that is printed on the cable, it may be necessary to use a translucent colorant that is also compatible with amides. The colorant can be applied in any of several colors depending on the desired cable color. The colorant that is to be applied to the outside of the cable could be a water-based or solvent-based solution. Water-based colorants can, in certain instances, be less hazardous for employees to handle as well as less hazardous for the environment. On the other hand, solvent-based colorant provide a shorter dwell time, and, thus, can help decrease the overall footprint of the coloring system. In certain examples, the solution values can range from concentrations of 1 gram/liter to 100 gram/liter or greater. The rate of the cable traveling through the system will depend on the colorant solution characteristics. For example, the faster it is desired to move the cable through the system, the higher the solution concentration will need to be. Additionally, various additives can be added to the colorant to ensure that the nylon readily accepts the colorant. It is also contemplated that a UV cured colorant can be used to color the cable.

It is also contemplated that the processes discussed herein could be used to color PVC and multiple other polymer insulations of cable in a post-production process or an in-line manufacturing process in addition to coloring the nylon jacketing that is over the top of the PVC insulation on THHN and similar constructions.

In one example, the cable can be passed through a bath or spray (or some other method of introduction) of the colorant solution. The cable can remain in the bath or spray for a period of time ranging from a fraction of a second to many seconds depending on the desired color density. In one example, the colorant can have a transparent characteristic to allow the printing on the cable to show through the colorant applied to the cable. The colorant can be applied in any of several colors.

In one embodiment a process for coloring cables post-production or in an in-line manufacturing process can include coloring a polymer or amide coated conductive cable or wire using a water-based or solvent-based colorant solution. The conductive cable or wire may have one or multiple polymer coatings comprising one or multiple polymers. In one example, the cable can be passed through a bath or spray (or some other method of introduction) of the colorant solution. The cable can remain in the bath or spray for a period of time ranging from a fraction of a second to many seconds depending on the desired color density. In one example, the colorant can have a transparent characteristic to it in order to allow the printing on the cable to appear through the colorant applied to the cable. The colorant can be applied in any of several colors. In one example, the process can be controlled automatically using electronics to measure and control any parameter, including; speed, temperature, colorant solution, tension, etc.

An example process can include passing an insulated cable having one or more of a printing or a logo through a coloring polymer (or colorant solution) for a predetermined period of time. The insulated cable or the colorant solution can be heated prior to passing the insulated cable through the colorant solution. The colorant solution can include a transparent characteristic in order to allow for the one or more of the printing or logo to appear through the colorant.

An example method for coloring an insulated cable having a covering can include providing a solution for coloring the covering of the cable a predetermined color, heating the solution to obtain a heated solution for coating the covering of the cable, advancing the cable through a coloring station at a predetermined speed to apply the solution to the covering for a predetermined duration to open up pores in the covering and to color the cable the predetermined color, and blowing air at the cable after the cable is advanced through the solution to remove excess solution from the cable and to dry and cool the cable. The speed of the cable can be set at 50 ft/min to 1000 ft/min, and the cable can be heated to a temperature of 100° F. to 300° F.

The method can also include submerging the cable in a trough, tank, chamber, or tube containing the solution, the cable can be maintained in the solution for a predetermined residence time to ensure that the solution is properly absorbed by or adhered to the covering of the cable. The solution can be applied in the form of a spray, and the spray can be pressurized such that the solution is pushed into the microscopic pores of the covering of the cable. The solution can be pumped through a heater to raise the temperature of the solution. The method can also include filtering sediment from the solution that enters the solution during applying the solution to the cable and adding buffer solutions, acid, and/or base to the solution to help maintain a consistent pH level of the solution and to improve the performance of the solution. The method can also include cycling the solution from the coloring station to a filter and through the heater and back to the coloring station for coloring the cable and providing the solution to the coloring station by a supply line connected to a solution tank. The applied solution can have a transparent characteristic to allow printing on the cable to appear after application of the solution, and the solution can be water-based or solvent-based. The method can also include heating the solution to a temperature of 130-230° F. and heating the cable by a heater to open up microscopic pores located in the covering. The solution can be applied in a pressurized chamber.

In another example, a system for coloring cable can include a payoff reel comprising cable for coloring, a cable puller configured to advance the cable from the payoff reel, a cable heater configured to heat the cable, solution for coloring the cable, a circulation system comprising a pump, a heater for heating the solution, and a filter for filtering particles from the solution, an air wipe for removing excess solution from the cable and for cooling the cable, and a take up reel for receiving the cable after the cable passes through the solution. The cable puller can be configured to pass a predetermined length of cable through the solution for a predetermined period of time, and the solution can have a transparent characteristic to allow printing on the cable to appear after exposure to the solution. The solution can be water-based or solvent-based, and the cable heater can be configured to heat the cable prior to passing the cable through the solution. The heater for heating the solution can be configured to heat the solution prior to advancing the cable through the solution. The system can include a trough, tank, chamber, or tube for receiving the solution, and a sprayer for spraying the solution onto the cable. The system can also include a shut-off mechanism configured to stop the cable from advancing if tension in the cable reaches a certain threshold to avoid damage to the cable and for operator safety. In one example, the air wipe can include a series of nozzles for projecting air at the cable after coloring.

In another example, a cable can include a first layer comprising a stranded or solid cable layer, a second layer comprising a coating layer. The second layer can include a colored portion extending partially through the second layer from an outer surface to an inner surface defined by an uncolored portion. The colored portion of the cable can have a color density, and the cable may include a UL legend printed on the cable, and the color density does not obscure the UL legend. The cable can meet UL flame testing, tensile/elongation, and cold bend testing specifications. The cable can have at least one additional layer, and the at least one additional layer can include a polymer coating. The second layer can be an outer layer and can be a polyamide coating layer.

The present invention is disclosed above and in the accompanying drawings with reference to a variety of examples. The purpose served by the disclosure, however, is to provide examples of the various features and concepts related to the invention, not to limit the scope of the invention. One skilled in the relevant art will recognize that numerous variations and modifications may be made to the examples described above without departing from the scope of the present invention.

1. A method for coloring a covering of an insulated cable comprising:
providing a solution for coloring the covering of the insulated cable a predetermined color;
heating the solution to obtain a heated solution for coating the covering of the insulated cable;
advancing the insulated cable through a coloring station at a predetermined speed to apply the heated solution to the covering for a predetermined duration time to open up pores in the covering and to color the covering the predetermined color; and
blowing air at the insulated cable after the insulated cable is advanced through the heated solution to remove excess solution from the insulated cable and to dry and cool the insulated cable.

2. The method of claim 1, wherein the predetermined speed of the insulated cable is within a range of 50 feet per minute and 1000 feet per minute.

3. The method of claim 1, wherein the insulated cable is heated to a temperature of 100° F. to 300° F.

4. The method of claim 1, further comprising submerging the insulated cable in a trough, tank, chamber, or tube containing the heated solution.

5. The method of claim 4, wherein the insulated cable is maintained in the heated solution for the predetermined duration time to ensure that the heated solution is properly absorbed by or adhered to the covering of the insulated cable.

6. The method of claim 1, wherein the heated solution is applied in as a spray.

7. The method of claim 6, wherein the spray is pressurized such that the heated solution is pushed into microscopic pores of the covering of the insulated cable.

8. The method of claim 1, wherein the solution is pumped through a heater to raise a temperature of the solution forming the heated solution.

9. The method of claim 1, further comprising filtering sediment from the solution that enters the coloring station during applying the solution to the insulated cable.

10. The method of claim 1, further comprising adding buffer solutions, acid, or base to the solution to help maintain a consistent pH level of the solution and to improve performance of the solution.

11. The method of claim 1, further comprising cycling the solution from the coloring station to a filter and through a heater and back to the coloring station for coloring the insulated cable.

12. The method of claim 1, further comprising providing the solution to the coloring station by a supply line connected to a solution tank.

13. The method of claim 1, wherein the solution has a translucent characteristic to allow printing on the insulated cable to appear after application of the solution.

14. The method of claim 1, further comprising heating the solution to a temperature within a range of 130° F. and 230° F.

15. The method of claim 1, further comprising heating the cable by a cable heater prior to entering the solution to open up microscopic pores located in the covering.

16. The method of claim 1, wherein the solution is applied in a pressurized chamber.

17. A method for coloring an outer covering of an insulated cable comprising:
providing the insulated cable, wherein the insulated cable includes an inner conductive layer comprising a stranded or solid wire, a central layer, and the outer covering comprising a nylon material;
providing a solution for coloring the outer covering of the insulated cable a predetermined color;
heating the insulated cable using a cable heater to open up microscopic pores located in the outer covering;
heating the solution to obtain a heated solution for coating the outer covering of the insulated cable, wherein the heated solution is contained within a trough that is connected to a circulation system, wherein the circulation system includes a pump, a heater for heating the solution, and a filter for filtering particles from the solution;
submerging the insulated cable into the trough containing the heated solution after the insulated cable is heated by the cable heater;
advancing the insulated cable through the trough at a predetermined speed to ensure that the heated solution is properly absorbed by or adhered to the outer covering of the insulated cable; and
blowing air at the insulated cable after the insulated cable is advanced through the heated solution to remove excess solution from the insulated cable and to dry and cool the insulated cable.

18. The method of claim 17, wherein the insulated cable is heated by the cable heater to a temperature in a range of a range of 100° F. and 300° F.

19. The method of claim 17, wherein the predetermined speed is between 50 feet per minute and 1000 feet per minute.

20. The method of claim 17, wherein the heated solution has a temperature within a range of a range of 130° F. and 230° F.
